(19) United States
(12) Patent Application Publication
(10) Pub. No.: US 2014/0129447 A1
(43) Pub. Date: May 8, 2014

(54) SYSTEM AND METHOD FOR ANONYMOUS MICRO-TRANSACTIONS

(71) Applicant: NetNumber, Inc., Lowell, MA (US)

(72) Inventors: Douglas J. Ranalli, Andover, MA (US); David P. Peek, Atkinson, NH (US); Arif Shaikh, North Billerica, MA (US)

(73) Assignee: NetNumber, Inc., Lowell, MA (US)

(21) Appl. No.: 14/070,883

(22) Filed: Nov. 4, 2013

Related U.S. Application Data
(60) Provisional application No. 61/722,521, filed on Nov. 5, 2012.

(51) Int. Cl. G06Q 20/38; G06Q 20/22

(52) U.S. Cl. CPC G06Q 20/383; G06Q 20/29
USPC 705/44

(57) ABSTRACT

Disclosed herein are systems, methods, and computer-readable storage devices for processing anonymous micro-transactions of any type, such as purchases, donations, subscriptions, rewards, and so forth. An example system configured for subscriptions can register a user by assigning the user an anonymous user identifier, and prefund a payment account associated with the anonymous user identifier from a third party payment service, based on authorization from the user. This process can be part of a separate registration phase prior to attempting any transactions. Then, the system can complete a subscription transaction as a micro-transaction via the payment account on behalf of the user in response to a user request made via a micro-transaction button on a website, for example. The system can maintain a subscription transaction history for the payment account, and confirm, upon request from a merchant, validity of the subscription transaction based on the transaction history.

### RELATED APPLICATIONS

This application claims priority to U.S. Provisional Application No. 61/722,521, filed 5 Nov. 2012, the entire contents of which are incorporated herein by reference in their entirety.

### BACKGROUND

1. Technical Field

The present disclosure relates to micro-transactions and more specifically to various improvements to commerce and advertising that can be enhanced by micro-transactions.

2. Introduction

In the physical world, an individual can put a small amount of cash or coins into his or her pocket and use this physical currency to complete fast, anonymous micro-transactions in the physical world. For example, a user can quickly pull $0.50 (as two quarters) out of his or her pocket to buy a newspaper at a kiosk on the street. This transaction is completed quickly and anonymously in the physical world but has no suitable analog in the online world. By comparison, in the online world users either get free access to content like a newspaper in return for viewing advertising, or content providers require users to purchase a subscription using a payment service such as a credit card or an online payment intermediary such as PayPal™. Paying for items online by credit card is quite common but the process is not fast and not anonymous. In fact, users are typically required to disclose valuable or potentially private personal identity information when completing an online credit card purchase. Rising disclosures of personal identity information has created a corresponding rise in “identity theft.”

Current payment systems have a multitude of potential problems preserving anonymity. Any information stored online is potentially subject to theft. Examples of theft of online personal identity information are seen daily in the popular press. Any time that an online service asks a user to register or provide personal identity information, that information is under a real risk of theft.

Another problem of current payment systems is that they only enable flows of money in one direction. Many online payment systems enable a user to pay money to a merchant or vendor for a product or service. This one-way flow of money from user to merchant is valuable but insufficient. The lack of an adequate two-way flow of money is an obstacle to online micro-transaction opportunities.

### BRIEF DESCRIPTION OF THE DRAWINGS

FIG. 1 illustrates an example high level system architecture for an anonymous micro-transaction system;

FIGS. 2A-2C illustrate an example component architecture for the anonymous micro-transaction system;

FIG. 3 illustrates an example network communications and computing environment for the anonymous micro-transaction system;

FIG. 4 illustrates an example button generator user interface;

FIG. 5 illustrates a first example method embodiment for subscription purchases;

FIG. 6 illustrates a second example method embodiment for collecting rewards or gifts;

FIG. 7 illustrates a third example method embodiment incorporating purchases and rewards; and

FIG. 8 illustrates an example system embodiment.

### DETAILED DESCRIPTION

A system for providing anonymous micro-transactions (“the system”) can resolve the problems and deficiencies indicated above, as well as providing other benefits. For example, the system can provide fast, anonymous online micro-transactions. The system enables a user to put a small amount of money, cash, coins, currency, or other value into his anonymous account for the purpose of using those funds to complete fast, anonymous micro-transactions in the online world. The user can then click on a purchase button to buy a 24-hour subscription to an online newspaper in a way that is just as fast and anonymous as pulling two quarters out of his or her pocket in the physical world.

Micro-transactions are typically small transaction that can be as small as $0.01 USD (one US cent) or smaller. Users of the micro-transaction system disclosed herein are “anonymous” in that the user is “known” by the third-party payment service used to prefund an anonymous micro-transaction account, but the user's identity is not known within the micro-transaction system. The micro-transaction system receives a unique ID from any payment service utilized to fund a micro-transaction account, which is stored by the micro-transaction system and can be utilized to return funds to a user via the user's indicated third-party payment service. The micro-transaction system can assign each user a unique and anonymous account ID or user ID that is shared with external merchants during settlement of micro-transactions. Thus, merchants have access to the anonymous user ID but do not know anything else about the user. Users of the micro-transaction system pre-fund an account, which can be used for two-way flow of micro-transactions between users and merchants, so users can pay money to merchants, and merchants can pay money to users. The micro-transaction system can facilitate subscription management as a list of active subscriptions purchased by a user. Examples include a subscription to access content a certain number of times, or a subscription to access content for some set number of hours, days, or months. The micro-transaction system can enable rewards for activities such as viewing an advertisement. Thus, the micro-transaction system can maintain a history of individual rewards received by each user so that users are prevented from claiming a given reward more times than the entity offering the reward intended.

In one embodiment, the system stores no user identity information. The system can operate without asking a user to register any personal identity information or by only asking for some minimal amount of personal identity information. The system does not store, for example, the user's name, address, phone number or email address during registration. Since the system does not store personal identity information, users' personal identity information cannot be compromised through the system.

Because users do no provide personal identity information, if a user forgets his or her account login information, such as a user name, password, or security-phrase, the system does not have available the usual options for providing account information to users. In one embodiment, the system can require users to pre-fund their account at the time the account is created, such as by transferring funds from other online payment services such as PayPal, Amazon Payments, or Google Wallet. When a user deposits funds into his or her account using an online payment service, the system receives two key pieces of data from the payment service: (1) an anonymous payment service account ID, and (2) a transaction ID. The system stores the payment service ID with the newly created account at the time of registration. If the user forgets his or her logon credentials, the system can recover the user's account by asking the user to refund the system using the same payment service. The system will receive the payment service ID and can look up the account associated with that payment service ID. As a result, the system can enable a user to recover a lost account by simply adding more funds into the system. In another embodiment, the system can offer users the option to enter a recovery e-mail address. The recovery email address provided by the user can be anonymous in that it conveys no personal information about the user (i.e. 12345@gmail.com).

The system can also provide for two-way flow of money—both user-to-merchant and merchant-to-user via a common transaction infrastructure. Thus, the system enables micro-transactions with much greater utility to both users and merchants. More details and illustrative examples of all of these various embodiments are provided below.

In one embodiment of the invention, the system for enabling anonymous micro-transaction payments can include various components. The system can include a first online payment system associated with a first online payment provider comprising at least one computer communicating with a computer network interface and a first data store and executing a first stored program to register non-anonymous users and to receive and process online payment requests associated with such users. The system can include a second online payment system associated with a second online payment provider comprising at least one computer communicating with a computer network interface and a second data store and executing a second stored program to receive and process anonymous online micro-transactions. The system can include an online purchase system associated with an online merchant comprising at least one computer communicating with an online portal, a computer network interface and a third data store and executing a third stored program to receive and process the user's online micro-transactions made via the merchant's online portal as anonymous payment transactions. The first stored program can store a user's personal information for an associated user account in the first data store, receive via the network a user's pre-fund request to transfer specified funds from the user account to the second online provider, process the user's pre-fund request to generate and transmit to the second online provider, via the computer interface, an anonymous account ID (aID), a transaction ID (tID), and the amount of the specified funds. The second stored program can receive and store the aID, tID and the amount of the specified funds in the second data store without storing any personal identity information about the user, and generate and transmit to the user, via the network interface, an anonymous identifier for authorizing one or more anonymous online micro-transactions for an amount up to the stored amount. Then the second stored program can receive a transaction request for a designated amount from the online merchant via the network interface with the anonymous identifier, and process the transaction request by determining whether the designated amount is less than or equal to the stored amount and if true, reducing the stored amount by the designated amount and transmitting an authorization for payment of the designated amount via the network interface to the online merchant. The third stored program can receive from the user via the merchant's online portal a purchase request for the designated amount along with the identifier, and process payment for the purchase request, without obtaining the user's personal information, by generating and transmitting to the second payment provider the transaction request for the designated amount.

The system can enable users and merchants to process transactions as small as $0.01 (one U.S. cent) or even fractional cents for buying or selling online content or services. The system enables online purchases, donations, subscriptions and reward transactions for as little as $0.01 while preserving user anonymity in all transactions with online merchants. Users can log in to online sites using their anonymous ID without disclosing any personally identifying information to the merchant. The system can enable merchants to keep up to 95% of the face value of micro-transactions, even at $0.01. The system enables merchants to track users (but not their identities) across multiple devices. In the context of a purchase, the system can enable a merchant to offer, within a website, email, PDF or mobile application, a one-time download of any type of premium content (such as a news article, MP3 audio file, video content, font, and so forth) for as little as $0.01 or offer one-time view/access to any type of online content (e.g. instructional video) for $0.01 to $0.50 or more. The system enables donations, such as a user or organization requesting a $0.50 donation for a worthy cause with a single click of a button from within an e-mail or web page. The system enables subscriptions, such as selling a 24-hour pass to view or access online content (e.g. daily-newspaper, recipe, etc.) for $0.25, while allowing a returning user to access the subscription from any device for the 24-hour duration. The system can enable paying a micro-transaction reward, such as $0.08, to a user for watching an online ad or performing some other task while automatically blocking repeat access click-fraud. The system can also allow a user to login to a secure website using a login button without requiring the user to disclose any personal information.

The anonymous micro-transaction system can protect user-identities via “anonymous user accounts.” Users create and pre-fund an account to buy content and services online at micro-purchase prices, make micro-donations, receive micro-rewards and login to websites without ever disclosing their personal identity to the merchant community or to other online entities. Thus, the system can provide enhanced anonymity and more efficient processing speed when handling micro-transactions. The system enables merchants to keep a substantial amount of the revenue generated by micro-transactions regardless of the amount of the transaction.

The system can provide merchants with five illustrative example services: purchase, donate, subscribe, reward, and login. These services can be combined in multiple ways to enable a wide range of online business models. The system can operate seamlessly with multiple currencies, with public or private debt, and so forth.

The system can provide a purchase service. The purchase service enables a one-time purchase of content or services. When a user clicks a purchase button embedded by a merchant in a web-page, e-mail, PDF or mobile-application, for example, the purchase button triggers an HTTPS request from the user's browser to a secure transaction node to approve or deny the purchase. Upon a successful transaction, the system redirects the user to the merchant defined Success-URL. The system can validate every purchase transaction to protect merchants against fraudulent “replay” of purchase confirmation messages. Micro-transactions are typically in the range of $0.01 to $0.50, but can include fractional amounts or amounts smaller than $0.01 or greater than $0.50.

The system can provide a donation service. The donation service enables a one-time donation from a user to an entity such as a qualified charitable organization, but which can also include other individuals or a business. The technical difference between a purchase and a donation transaction is that donation transactions do not require the receiver to “validate” each donation confirmation message. Hence, a charity can utilize the donation service without being required to interact with the system to validate confirmation messages.

The system can provide a subscription service. The subscription service supports configuration of a multi-use subscription entry in the system database to support returning-user access to content or services. A merchant configures the subscription button with the duration of the subscription and the system will automatically allow the user repeat access (from any Internet device) a defined number-of-times or a duration-of-time. For example, the number of times can be one time, X number of times, or unlimited times. The duration of time can include Y-hours, X-days, or some fixed number of days, such as 30 days. The system can provide a returning-user button that works in coordination with the subscription service to provide users with return access to a paid-for subscription. When a user clicks on a returning-user button, the button triggers a secure message sent to the system to determine whether the subscription is valid for the user.

The system can provide a reward service. Merchants can use the reward service to reward users for their time, attention, or other actions by contributing funds into the user's account. When a reward button is configured, the merchant defines the amount of money to be returned to the user and the maximum number of times that a user may claim a given reward. The system can monitor repeat user requests for rewards and automatically cancels any reward requests that exceed the allowed limit.

The system can also provide a login service that enables a merchant to efficiently authenticate and track users across multiple access devices using only their ID. The login service can be a free service offered to merchants to identify users through their unique system ID (such as a123-bc2q). When a user clicks on a login button, the system can authenticate the user and return a validated ID to the merchant.

A user can be defined as any individual who creates and funds an account and uses the account to buy online content and services, make charitable donations, or receive rewards starting as low as $0.01 per transaction. Users can pay an account funding “processing fee” and/or a monthly maintenance fee, such as $0.05/month, to maintain an account. Users can fund accounts via payment services such as a credit card, debit card, PayPaI™, Amazon Payments™, or Google Wallet™.

A merchant can be defined as any person, entity, or organization that offer users the option to (1) purchase premium content or services with the simple click of a purchase button (2) receive a reward, (3) make a donation, (4) access an online subscription or (5) login to a secure site with a secure, system-provided ID.

The system can provide clickable buttons for users to perform actions via the system. For example, merchants can offer content and services for sale, charities can request donations, merchants can offer users rewards, or can enable users to login to a service via a button which only requires users to disclose only their account ID. Users can then click on the button, provide their account credentials, and initiate the desired action. Merchants can easily integrate such buttons into a web page, email, PDF, or mobile application. The system can specify or control the design of the button, but merchants can control the content can modify the button size, label, currency, amount, action, etc.

The system handles new users via an automated user registration process. For example, when a new user first clicks an action button, the system can prompt the user to create and fund an account. New users are directed to a secure portal where registration takes less than 60 seconds to complete. The user can fund a new account with a minimum of $0.99 using a credit card, debit card, PayPal™, Google Checkout™ or Amazon Payments™, for example. The system can handle existing registered users by asking the user to sign in to complete the transaction. The system can remember the account credential as valid for the duration of the user's browser session, so the user does not need to “sign-in” for every transaction. The system can prompt users to “approve” each transaction, such as purchase, donation, or subscription transactions, prior to removal of funds from the user account. The system can bypass the approval process for transactions from trusted merchants, or based on user preferences on a per-merchant basis. This enables the user to complete micro-transactions with a single click of a button. Users can manage or administer their own accounts and view transaction history via an online portal or management web page.

The self-service account management portal can provide functionality such as viewing a list of all purchase, subscription, donation and reward transactions processed over the past 90 days. Transaction specific services can include request a refund on a specific transaction if that merchant allows refunds. Another transaction specific service can be providing feedback. Users can provide feedback on a specific transaction to highlight particular positive events, problems, or other general feedback for that merchant. The system can use feedback to improve the service, to monitor the system for problems, generate analytics data or competitive analysis data, or to provide user feedback to the appropriate merchants. The self-service account management portal can also allow the user to manage trusted merchants. The portal can provide a list of all merchants that a user has previously designated as a “trusted merchant.” The user can add merchants to the list to avoid having to “approve” each transaction with a trusted merchant, and likewise can remove merchants from the list to restore the “approve transaction” step for those merchants. The self-service account management portal allows users to add funds to an existing account outside of the typical transaction approval process. The self-service account management portal can also allow users to close their account and optionally receive a refund of at least part of the unused balance in the account.

The system can provide a corresponding merchant portal for merchants to manage their accounts, review transactions, manage their buttons, and so forth. Via the merchant portal, merchants can create a merchant account. Online account administration features can include but are not limited to managing administrators, linking to a parent account, editing settlement instructions, and so forth. The system identifies merchants via a validated domain name that the merchant owns or via which the merchant operates, such as the-merchants-name.com, or via a specific URL such as webhosting.net/merchant. Thus, merchants can manage the validated domain names from which buttons or other actions are allowed. The system can validate that the merchant has control over a domain or web page by requesting that the merchant publish an HTML validation script to a designated web page under the domain to be validated. The merchant portal can provide detailed implementation guides for common merchant implementation use cases, such as “Purchase button on webpage”, “Donation button in Gmail message”, “Purchase with 24-hour subscription”, and so forth.

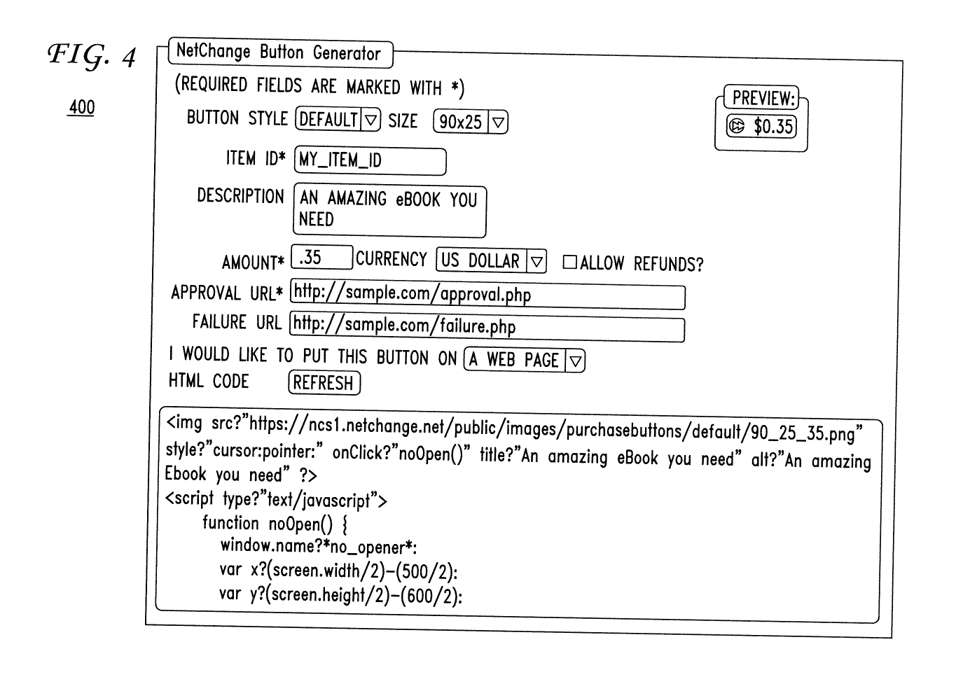

Merchants can generate, publish and manage buttons via the merchant portal. Merchants can create a new button, such as for a purchase, reward, donation, login, or subscription service, using the button generator in the merchant portal. Merchants can view a list of active buttons via the merchant portal and edit the buttons online. All button parameters are stored via the system or via a “cloud service” so changes to button parameters become effective immediately. FIG. 4 illustrates an example button generator user interface 400, that shows how a merchant can specify a button style, an item ID, a description, an amount, an approval URL and a failure URL, a target destination for the button, as well as other details. The button generator user interface 400 can then produce HTML code that the merchant can copy and paste directly into their web page to display the button in the appropriate location. Similarly, the button generator user interface 400 can generate other code, files, or data to insert into other targets, such as a kiosk, native application, PDF document, email, and so forth. In some cases, the button generator user interface 400 can provide multiple target destinations, and can provide a testing button for the user to preview what the button will look like and how the button will operate based on the user-provided parameters.

Merchants can select a currency via the merchant portal. The system can support any currency or medium of stored value. The system can automatically convert from the merchant-defined transaction currency, such as the Euro or Yen, into the user's local currency, such as US Dollars, at the time a transaction is approved based on exchange rates updated using industry standard conversion sources.

The system can track a transaction history for merchants, over a period of time, such as seven days, or over a shorter or longer period of time. The system can allow merchants to export this transaction history. The merchant portal can provide an online report showing product-specific transaction activity over the past seven calendar days. Online reports can include each product (purchase, donation, subscription, reward, login). The system can provide full transaction details for download. The system can also provide monthly settlement services. For example, the system can post a monthly settlement report in PDF format to the merchant portal each month for optional view/download.

The system can transmit electronic settlement payment to merchants once per month, at some other interval, when the balance exceeds a specific amount, or upon request from the merchant. The system can provide automated settlement via ACH transfer to a merchant's bank account or via payment to a PayPal account, for example. The system can charge a processing fee on the settlement report which includes internal processing fees and external costs. Merchants can allow users (either all users or approved users) to cancel individual transactions via the online user portal.

Buttons are one practical mechanism by which merchants offer content and services for sale, request charitable donations, offer users rewards, or enable users to login to a service without disclosing their identity. Merchants can publish buttons within a webpage, email, PDF, or mobile application. When a user clicks on a button, the system initiates a sequence of secure messaging transactions between the merchant, user, and the system to authenticate the user and authorize (or deny) the transaction. The system can provide a button-generator service for automated generation of merchant-specific transaction buttons. Merchants can access the button generator via the merchant portal.

The button generator can allow the merchant to create button types such as Purchase, Donation, Subscription, Returning User, Reward, or Login. The merchant can define various button parameters that modify functionality of the button. The set of parameters can vary based on the type of product (i.e. purchase, donation, reward, subscription, and login). Some example button parameters and short descriptions are provided in the table below:

| | |
|---|---|
| Button ID | unique identifier for each button in the micro- |
| | transaction system |
| Type | type of button - purchase, donation, subscription, etc. |
| Merchant ID | identifies the merchant |
| Label | text string included on button e.g. “Download $0.25”, |
| | “Login”, “Returning-User”, etc. |
| Item-ID | inventory tracking number assigned by merchant to |
| | item |
| Description | common language description presented to user for |
| | transaction confirmation |
| Local currency | selection from list of 100+ currencies supported |
| Price | price in local currency units |
| Refund Policy | option to “enable” or “disable” user self-service |
| | refunds |
| Subscription | optional subscription duration i.e. 1-time, X-times, Y- |
| | hours, Z-days |
| Success URL | web address to direct user when transaction is |
| | successful |
| Failure URL | web address to direct user when transaction fails for |
| | any reason |

The output format parameter can include HTML, web page, email, document, web application, or other output formats as adapted for changing needs of merchants and users.

Merchants can manage their inventory of buttons via a list-management service on the merchant portal. The system can maintain a current list of active buttons either in the system storage or in a cloud-based or network based service accessible via the merchant portal. From the portal, a merchant can create, manage, edit, or delete existing buttons. Once a button is edited, the system automatically loads the new button parameters for immediate activation. As a result, merchants can easily modify the parameters of a button (label, currency, amount, subscription, etc.) without making any change to deployed website code or application code.

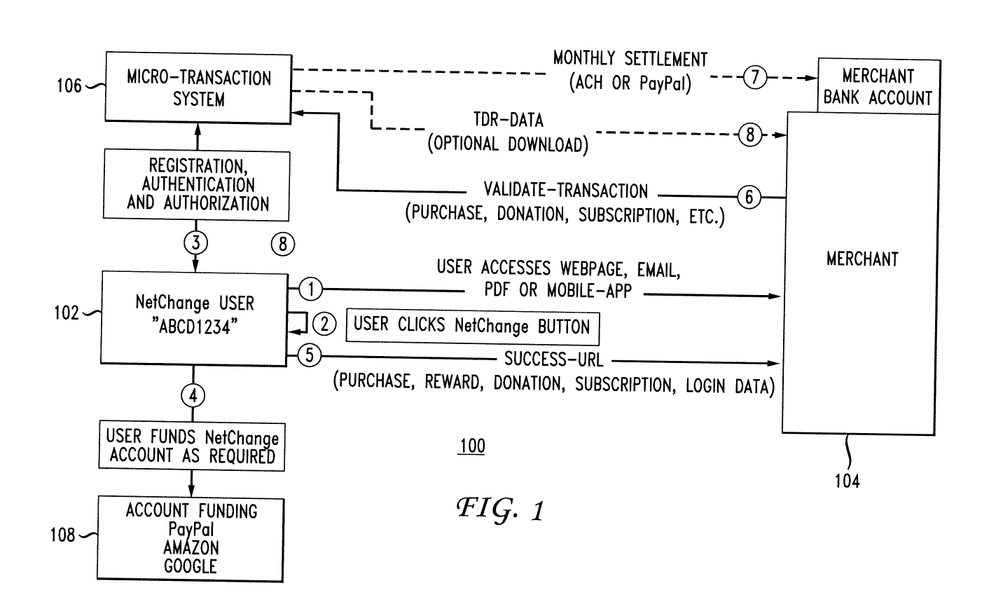

FIG. 1 illustrates an example high level system architecture 100 for an anonymous micro-transaction system. The system can incorporate multiple services deployed across multiple secure, scalable, redundant data centers, to provide redundancy and reliability. While this is one illustrative example, the architecture can be modified for other configurations as well. The example architecture 100 includes a micro-transaction system 106 that interacts with a user 102, a merchant 104, and one or more third-party accounts 108. At step 1, the user 102 accesses the merchant 104 via a button embedded or presented in a website, email, PDF document, or mobile-application. The button can be a purchase button, donation button, a subscription button, or some other button triggering a transaction. At step 2, the user 102 optionally clicks on the button to complete the desired transaction. The type of button varies based on the business use-case, and can include purchase, donation, subscription, reward, etc. At step 3, clicking the button triggers a messaging exchange between the user 102 and the micro-transaction system 106, such as secure HTTPS messaging. In one variation, the button can cause the system to identify and communicate with the nearest transaction node of the micro-transaction system 106. The messaging can vary based on the nature of the user. If the user 102 is a new user, the micro-transaction system 106 can guide the user through an account registration process. If the user 102 is a returning user, the micro-transaction system 106 can prompt the user 102 to log in if necessary and approve or authorize the transaction.

At step 4, if the user 102 needs to add funds to their account to complete the transaction, the micro-transaction system 106 can direct the user 102 to authorize a desired third-party payment service 108 to complete a funding transaction to the micro-transaction system 106. The third-party payment services 108 can communicate directly with the micro-transaction system 106, through logic embedded in or driving the button, or through the user 102. At step 5, if the transaction is approved, the button or the micro-transaction system 106 can redirect the user to a previously indicated success URL as defined by the merchant or other entity that created or specified the button parameters. Typically, the merchant 104 will host the success URL. The success URL can vary for every button generated by the merchant 104. If the transaction fails, the micro-transaction system 106 can redirect the user to a merchant-defined failure URL, which can provide additional support or help for the user 102, provide an error message or explanation of what failed, or can prompt the user to correct the deficiencies of the transaction.

At step 6, the merchant 104 validates the transaction using a function call to the micro-transaction system 106. The transaction can be one or more of a purchase, donation, subscription or other type of transaction. The micro-transaction system 106 can expose this functionality to merchants via an API or SDK accessible via a number of platforms. In the case of web-based communications, these platforms can include PHP, JSP, or ASP. At step 7, the micro-transaction system 106 can send a monthly settlement to the merchant-defined bank account via ACH, to a merchant PayPal account, or via some other transfer of funds, credits, or value. At step 8, the merchant 104 can download transaction detail record (TDR) data for all transactions with the micro-transaction system 106.

The merchant 104 can test the micro-transaction system 106 system using a “trial-user” account that is automatically generated by the merchant portal. Thus, merchants do not need to validate accounts against a “sandbox” or testing system, and then deploy separately in production. All testing can be performed against the production micro-transaction system 106 using the trial user account. The merchant-specific trial user account only works with buttons for a specific merchant and no funds are transferred through trial user accounts. The micro-transaction system 106 monitors the use of each merchant-specific trial user account and reserves the right to cancel the account if abuse is suspected or identified by an administrator.

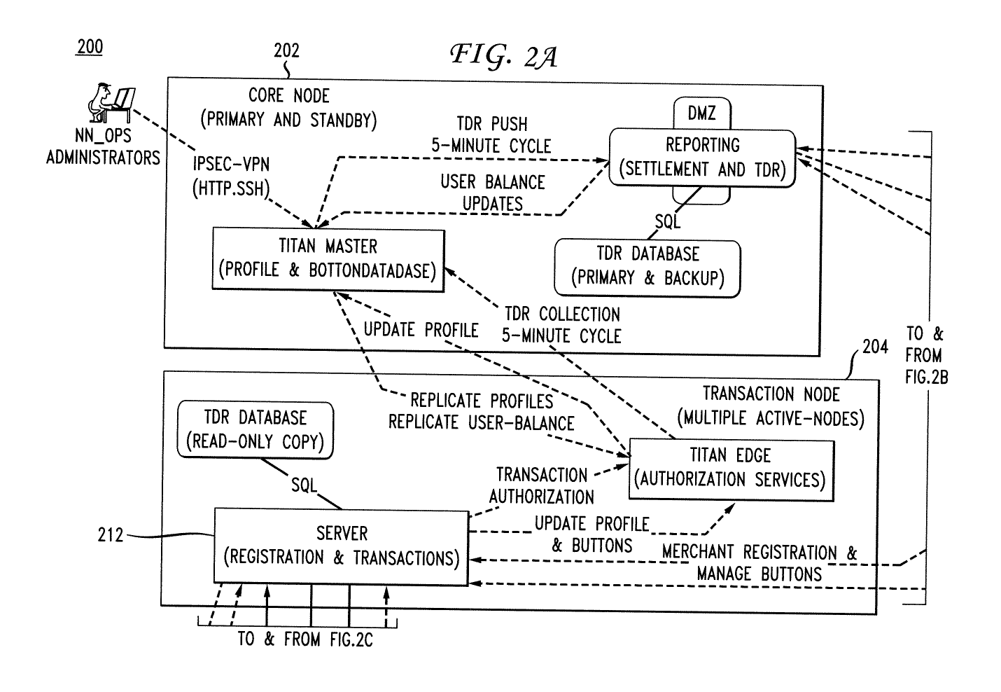

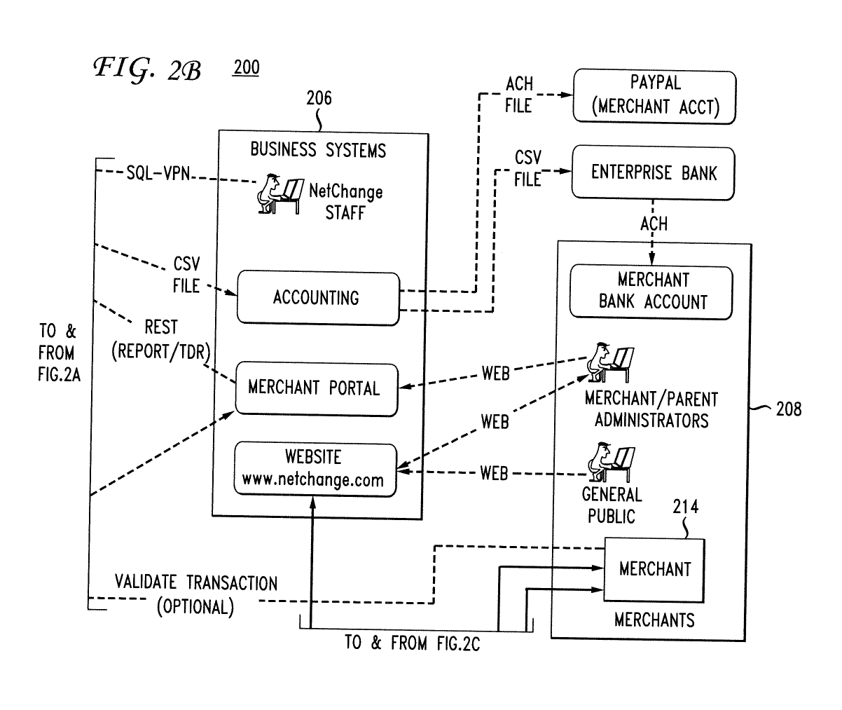

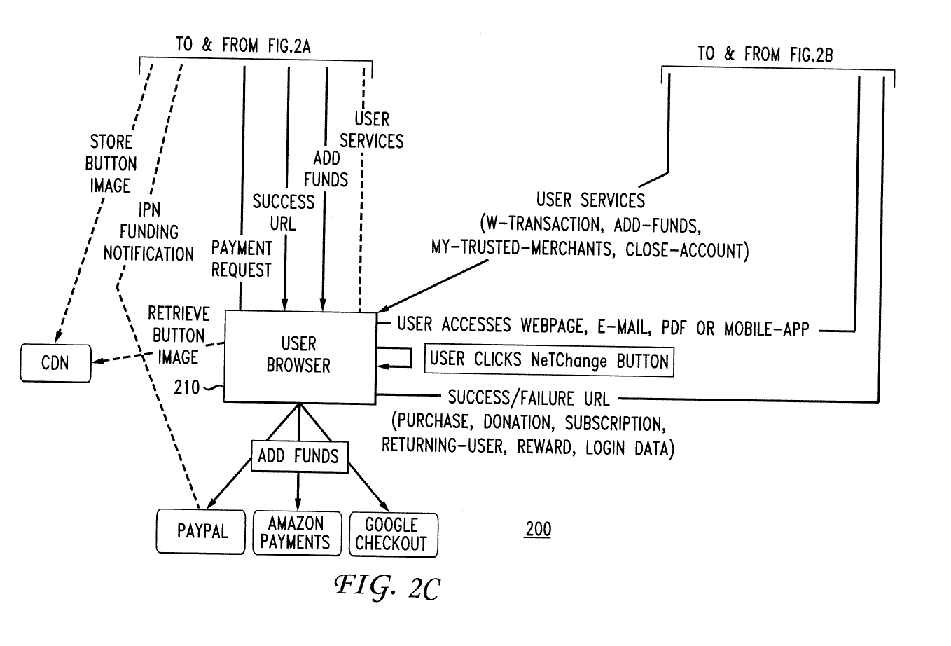

FIGS. 2A-2C illustrate an example component architecture 200 for the anonymous micro-transaction system. The micro-transaction system 106 can include a server 212 for registering and handling transactions for a user via a user browser 210. The server 212 can be part of a transaction node 204. The transaction node 204 can be one of multiple transaction nodes which synchronize and coordinate with a core node 202. Business systems 206 can interact directly with the core node 202, such as to manage buttons, coupons, rewards, customer tracking, viewing and confirming user subscriptions, viewing analytics data, and so forth. Merchants 208 can access the core node 202 indirectly, such as through a website interface or a merchant portal through the business systems 206. The various arrows and explanations shown in FIGS. 2A-2C illustrate various interactions between the components to complete certain transactions or functionality.

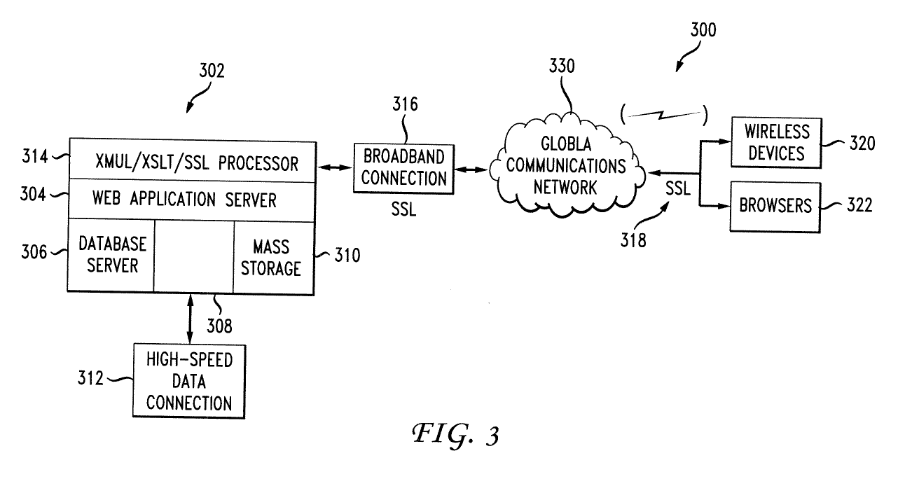

FIG. 3 illustrates an example network communications and computing environment 300 for the anonymous micro-transaction system and illustrating communications between one or more of the user, the micro-transaction system, merchants, and account funding entities or third-party payment systems. In one embodiment, the system 300 includes a platform 302 that hosts at least a data management tool, here a web application server 304. The server 304 provides a common layer to access underlying services that can include a database server 306, a mass storage 310, and an interface 308 to a high-speed data or network connection 312 to accommodate processing, storage and/or communications with remote locations and/or users from virtually any accessible network node. Further, the platform 302 can include a processor 214 suitable for XML (extensible Mark-up Language), XSLT (XML Stylesheet Language, Transformations), and SSL (Secure Sockets Layer) processing. The processor 314 can also access web based services utilizing SOAP (Simple Object Access Protocol). A high speed connection 316 (e.g., broadband) can interface to the processor layer 314 for multiple communication exchanges with remote users disposed on a global communications network 330 (e.g., Internet). The remote users can access the platform 302 via an SSL connection 318 using portable wired/wireless devices 320, or by way of the associated browsers 322, or other applications.

Having disclosed some example architectures for handling micro-transactions, the disclosure turns now to several use case examples to illustrate potential uses of the architectures and variations thereon. A first use case scenario is selling electronic documents such as brochures, books, magazines, and so forth. In current approaches, a publisher creates electronic content, and makes the content available for download via an online content distribution service where users can purchase a download of the content. Then users can pay for and download the content. Typically the user has unlimited access to the content once it has been downloaded. The publisher typically expects the user to pay in advance before receiving the download because the publisher has no way of protecting the content once it has been downloaded. In this use case scenario, the micro-transaction server allows a different approach.

The publisher makes valuable content available in the form of an electronic document, brochure, newsletter, book, magazine, video, song, PDF document, etc. that is modified to include a subscription page that enables a user to pay for access to the content using the micro-transaction system. The system can present the subscription page to the buyer at the time the file is opened or after the buyer has been allowed to view/preview some percentage of the material at no cost. Once the subscription page is presented, the buyer cannot view the remainder of the file without paying for a subscription using the micro-transaction system. Multiple technical implementations of this content protection model are possible. A subscription could take the form of (1) one-time use, (2) multi-time use, (3) access for a period of time, (4) unlimited access, etc. Pricing may vary for each different type of subscription or duration of subscription. Subscriptions can include a single piece of content or a library of content. When the buyer clicks on the button to use his/her anonymous micro-transaction account to pay for the subscription, the micro-transaction server keeps track of the terms of the subscription so that the buyer can access the content again during the purchased subscription term.

This example use case can include several advantages. For example, publishers can send their valuable content out to any number of users via a free distribution mechanism like email at virtually no distribution cost. Broadcasting the content to users can expose the content to a much larger audience of potential buyers by comparison with waiting or hoping for a user to visit a content distribution site to select and prepay for a given piece of content, or waiting for the user to discover the content. Further, users can potentially preview the content before purchasing a subscription. Users can purchase a small subscription (e.g. one-time use) or an extensive subscription (e.g. unlimited use) according to his or her individual needs. Publishers can dynamically change the terms of the subscription options by editing the parameters of each subscription button published in the electronic content. For example, a publisher can change the price of subscriptions after some period of time. Older historical content might be more or less valuable than current content so the price might change over time. The price may change dynamically based on demand. The micro-transaction system allows merchants to edit the terms and conditions of any button by editing the button parameters that are stored in, hosted by, or provided by the micro-transaction server.

A second use case scenario is merchant verification by user activity. In current approaches to this use case scenario, individuals who visit merchant websites to purchase content, services or products have a range of options available for determining if the merchant can be trusted. Past experience and word of mouth from other trusted Users represent common ways of determining if a merchant is trustworthy. A key limitation of direct experience and word-of-mouth verification of merchants is that each individual user only has direct experience with a limited number of merchants and only has indirect experience through a limited number of other trusted users who can pass along word-of-mouth verification.

The micro-transaction system enables users to buy content and services online at micro-purchase prices, which can lead to a much higher number of merchants selling content using micro-transaction system and pricing. As a result, users can buy content and services from new merchants without any effective means of determining or confirming trustworthiness of new merchants. Thus, the micro-transaction system can track the number of users that have completed a transaction with a given merchant and also track the number of users that have provided negative feedback on their experience with a specific merchant via the micro-transaction system user support website. The micro-transaction system can dynamically display to users the absolute number of complaints received from other users regarding a merchant or regarding a specific item being sold by a merchant. The micro-transaction system can dynamically display to users the percentage of times other users complain about a merchant or about a specific product made available for sale by the merchant. The micro-transaction system can dynamically display historical user feedback statistics at the time that a user is being asked to confirm/approve a transaction from a specific merchant.

This use case scenario including the micro-transaction system can provide several advantages. For instance, the micro-transaction system can provide valuable user satisfaction information to members of the micro-transaction community without disclosing any identifying information about the users who are providing the feedback. In order to provide feedback on a specific transaction a user must pre-fund his/her micro-transaction account and complete a transaction with the merchant before providing feedback. The requirement to prefund a micro-transaction account and the requirement to complete a transaction with a merchant before providing feedback can reduce the risk of bad-actors creating micro-transaction accounts for the purpose of providing false feedback about a given merchant. The net result can be a more accurate and valid community of feedback on the merchant. Thus, every micro-transaction user can benefit from the collective experience of the entire community when visiting a new merchant site.

A third use case scenario is user rewards for viewing advertisements or promotional videos. Under current approaches, individuals browse the Internet visiting multiple websites. When a user visits a website or specific webpage, the webpage can present advertisements. In most cases, an ad serving company selects the advertisements to display, with the goal of displaying ads that are pertinent to each user. Ad serving companies use multiple techniques to track user behavior and activity with the goal of understanding what the user is likely to find interesting so that useful ads can be presented. The website owner is paid a fee for displaying the ads to the user. In many cases, the fee to the website is based on the number of users that actually click on a given advertisement. Thus, website owners are motivated to generate maximum revenue from each user visit to the site. Users are motivated by getting free (or subsidized) access to the website in return for viewing ads. In some cases, the ads are presented in a way to “block” access to the site until the user has spent some amount of time viewing the advertisement, especially in the context of presenting online video.

Advertisers are motivated by exposing their advertisement to the largest possible audience of interested users. However, advertisers do not want to pay per click for fraudulent user activity. The concept of “click fraud” is well understood in the industry. Click fraud comes from repeat “clicks” by a user who really isn't interested in the advertiser's product but is clicking on the ad just to generate revenue for the website at the expense of the advertiser. Click fraud is a problem because it is difficult to recognize a “unique user” who is accessing an advertisement repeatedly. The ad serving company is motivated to build a system that delivers the maximum number of valuable “clicks” to online advertisers and the maximum money to websites that agree to allow the ad serving company to display ads.

The micro-transaction system can improve this use case scenario. The micro-transaction system can work with one or more ad serving companies to integrate micro-rewards into ad delivery services so that individual users can claim a micro-transaction cash reward for viewing an online advertisement. In one embodiment, a user who clicks on an advertisement is presented with a reward button after viewing the ad so that the user can claim a reward. The reward button can be presented before the ad, or during the ad to ensure that the user is present, participating, engaged, and paying attention to the ad. The reward can be some fixed amount regardless of the type of ad or a percentage of the value of the ad to the advertiser. For example, the ad serving company may agree to share 10% of the click fee with the user. Users can log into their micro-transaction account to claim the reward, either before, during, or after the advertisement is presented. The micro-transaction system can require users to pre-fund their account before using the account to collect rewards for viewing advertisements. Since the micro-transaction system requires a user to pre-fund a new micro-transaction account, users are unlikely to create many micro-transaction accounts just to gain access to more than one reward from a company. The micro-transaction system can identify repeat clicks by a user even if the user accesses a given advertisement from multiple different devices at different times. As long as the user is asked to login to his or her micro-transaction system account to obtain the reward, then the micro-transaction system can identify repeat accesses. Advertisers and/or merchants can set the terms of how many times an individual user can claim a reward for viewing an advertisement. Using the micro-transaction system, ad serving companies can dynamically change the terms of a reward button based on the changing value of a “click” for a given advertisement, or based on metrics or a budget for a particular advertising campaign. This approach can be used to finely tune a particular advertising campaign to a particular time, region, or demographic. User rewards for advertisements can apply to traditional content websites such as Yahoo.com as well as to social network sites such as Facebook or Twitter. User rewards can also apply to advertising in mobile devices.

Facebook and Twitter are effectively content publishers just like a newspaper company is a content publisher. One difference is that the users generate the content on social media sites. If people know they can get paid to click on a sponsored Tweet or a Facebook site, click rates should go up dramatically because the searches, tweets, profiles can easily be shared, and forwarded. In one example, Pepsi is a sponsor on Twitter. If Lady Gaga (or someone else with a large number of Twitter followers) sends out a message to 20 million followers with a Pepsi link at the foot of her Tweet the click-through-rate (CTR) will go up if people know they will get paid to click it, even at a micro-transaction payment level of one cent. A user's time and attention is a valuable commodity. If a user only has one hour to spend on his or her smartphone or tablet, the user is likely to prefer ads that provide a reward. Thus, social networks that partner with the micro-transaction system to offer rewards to users can command a compelling advantage and traffic driver.

This approach can provide multiple benefits. For example, the merchant, advertiser, and/or the micro-transaction system can pay users for the valuable time and attention spent viewing online advertisements. Users appreciate being paid for their valuable time, which can translate into a positive feeling towards the advertiser and the website that displayed the advertisement. Users are only able to collect the number of rewards allowed by the advertiser. The micro-transaction system can automatically enforce these limitations. Advertisers can benefit from greater user satisfaction. Advertisers benefit from identifying repeat user “clicks” on the same ad so that these repeat clicks can be identified as “click fraud” and removed from the system, and the advertiser can stop payment of rewards for such click fraud. Ad serving networks can benefit by delivering a more valuable service to their advertisers. Websites can benefit from increased revenue because users are more likely to click on an ad if the user is being paid a reward for viewing the ad. Advertisers can drive down the “cost per click” if websites can generate increased revenue because of higher click rates by users. Users are more willing to click on more advertisements, which allows ad serving companies to provide a better service to their advertiser customers.

In a fourth use case scenario, the micro-transaction system enhances exposure of advertisements to qualified customers. Currently, online advertisers have a difficult time placing their advertisements in front of qualified customer prospects on the Internet. Advertisers who accidentally stimulate a non-qualified customer to click on an online advertisement end up paying a per-click fee to an ad placement firm without receiving any real value. Advertisers who fail to place their advertisement in front of a qualified buyer miss the opportunity to influence future purchase behavior. The ideal situation is for advertisers to be able to identify in advance that a particular individual is a valid qualified customer for the products/services being advertised.

The micro-transaction system can address these problems by enabling advertisers to identify interested customers “in advance” by sharing the user-specific anonymous micro-purchase information generated by the micro-transaction system with advertisers. By way of background, the micro-transaction system enables users to purchase content and services, make donations, and register for subscriptions online at micro-purchase prices. As part of the micro-transaction system, registered users can view a historical list of purchase activity online via a user portal. Users can request a refund for specific transactions or provide feedback on specific transactions via the user portal. For example, user A pays $0.35 to watch an online video about healthy eating. The micro-transaction system can share this anonymous micro-purchase activity information with advertisers who may be interested in reaching users like user A.

The micro-transaction system allows an online advertiser to sponsor a user's micro-transaction by placing an online advertisement next to the transaction on the view transactions page in the portal. In one implementation, advertisers can use the micro-transaction data to identify users with interest in a particular subject, and use this information to place a context specific advertisement on the view transactions page in the portal. In one implementation, the advertiser can offer a reward to the user for viewing the advertisement. Simply presenting a context specific advertisement to a very targeted user may be worth enough to the advertiser to fully pay for the user's micro-transaction. For example, in the use case where user A has paid $0.35 to watch a video about healthy eating, an advertiser like Whole Foods Grocery Store might offer to sponsor this purchase in return for the user watching an advertisement from Whole Foods. From the view transactions portal the user has the option to “click” on the Whole Foods ad to get a reward of $0.35 for watching the context specific advertisement. Alternatively, if the user chooses not to view the ad, the user pays the S0.35 for the micro-transaction out of the pre-funded account.

This approach can provide a number of advantages. For example, internet advertisements are converted from a forced product or a blocked product into a purchased product. For example, when a user watches a video on YouTube or some other video sharing site, he or she often does not sign up to see ads—the ads are forced on to the user or the user blocks them. The same is true of virtually all Internet-based advertising. However, when a user goes to the micro-transaction system user portal, the user does not expect advertising content. The user expects to audit and review transactions. The user is already paying attention, so advertisers can sponsor content by not forcing, but rather offering users the opportunity to watch a video, hear a corporate song, or fill out a survey to get their content for free. Users can actually agree to watch ads without any imposition whatsoever and by their own choice. Another benefit to the user is the option to watch an advertisement at a convenient time and not at a time when the advertiser is trying to force you to pay attention to an ad even though the user visited a website to accomplish some other task.

A fifth example use case enables micro-transactions via text message. In current approaches, online entities can use mobile SMS text services as a mechanism to raise money from individuals who have mobile phones. The common implementation model is to broadcast a message to a large user community via TV, Twitter, Facebook, etc. asking users to send a text message to a special number to authorize a purchase or authorize a donation using the mobile bill as a payment system. Mobile operators charge a fee to online entities that use SMS texting as a mechanism for raising money. For example, a mobile operator might charge a fee that is as high as 30% of the value of the transaction in return for using the SMS texting service and the mobile payment service.

The micro-transaction system allows online entities to sell content and services or collect donations from users with mobile phones by linking a user's mobile phone number to his/her micro-transaction account. For example, President Obama sends a Tweet to several million followers asking for a $0.50 donation to his campaign using the micro-transaction system by sending a text message to the following micro-transaction SMS service (e.g. by texting 23456) to authorize the donation. The micro-transaction system receives the SMS messages and captures the user's mobile phone number. The micro-transaction system identifies the user's micro-transaction account from the user's mobile phone number, and proceeds to process the $0.50 donation. The micro-transaction system may or may not send a confirmation SMS to the individual. This approach is less expensive to process a donation using a pre-funded micro-transaction account than using a user's mobile billing service. It is more convenient for users to keep track of small financial transactions using the online micro-transaction system view transactions portal than it is to monitor activity on a mobile phone bill.

A sixth example use case scenario enables users to pay for coupons. Companies who are interested in stimulating a user to try a new product often distribute coupons to users via a variety of distribution systems. For example, companies often mail coupons to users, print coupons in newspapers, hand out coupons on the street, post coupons in stores, email or advertise coupons online, and so forth. Online coupon distribution systems exist are often highly inefficient because they don't properly address or resolve the manufacturers or consumer's problem. Further, many online coupon sites are not adaptive in that all users receive the same coupon or set of coupons.

The manufacturer wants to generate consumer interest in a product or service for sale, uphold consumer interest in an existing product, persuade the consumer to buy their product, not buy their competitor's product, use the product as an introductory tool to generate interest in the manufacturer's other products, and so forth. The consumer typically wants to try a new product before paying full price, try a new application of an old product before paying full price, save money on existing products either via bulk offers, discounts, bundling, or other common marketing tactics, and so forth. Some of the problems with current coupon systems are that the merchant doesn't always “know” the customer's goals or desires, or what the customer has already purchased, or what other merchants have offered to the customer. Similarly, the customer may not know what the customer wants, or what the merchant has.

The micro-transaction system can provide a service for customers to buy one or more coupons associated with a product category. In one example implementation, the customer types in a general product category like “Ketchup,” and the micro-transaction system can present a list of coupons from merchants who manufacture or sell “ketchup.” Kraft may offer a two-for-one coupon for $0.10, Hellman's may offer a $1.00 off coupon for $0.15, and Shop'N'Save may offer a 24 oz. jar for the same price as a 16 oz. jar for $0.05. The user can select the Kraft coupon offer and pays $0.10 to purchase the coupon via the micro-transaction system. The micro-transaction system can inform all the competing merchants in the system that a user purchased a coupon for ketchup for $0.10. In this way, the participating merchants may adjust the terms or cost of their coupons in an attempt to win the business of the next user who searches for ketchup or for a related coupon. The micro-transaction system can provide information to merchants to support the offer/bid process by sharing anonymous user purchase information with participating merchants. In this way, the micro-transaction system can make the coupon market a competitive, transparent, and adaptive market that allows users to broadcast their desired and purchased coupons to manufacturers and make manufacturers compete for their patronage. Because this is an adaptive market, the analytics and tracking data can be adapted for segments of the market, so that the purchased coupons in one region or demographic niche can be used to refine offers in similar situations, with little or no influence on other regions or demographic niches. For example, a single college student may have different coupon preferences than a family with 6 children. In one possible implementation, if a user downloads a coupon, the micro-transaction system can credit the $0.10 paid by the user to the coupon provider's account as a micro-transaction. In another possible implementation, the micro-transaction system retains the $0.10 fee as payment for providing the coupon matching service, or the micro-transaction system and the merchant share the fee.

By using the micro-transaction system, companies can offer coupons to micro-transaction users who have shown an interest in their product/service as a result of previous micro-transaction behavior. Companies who offer coupons via the micro-transaction system can limit the system to provide just one coupon per registered user. Since the micro-transaction system requires a user to pre-fund a new micro-transaction account it is unlikely that users will create many micro-transaction accounts just to gain access to more than one coupon from a company. Hence, the micro-transaction system solution can dramatically reduce multiple-use fraud/cost associated with offering coupons. Thus, companies will be able to offer more valuable coupons to users because the user is limited to just one coupon and the company is confident the user is a qualified lead because the user paid real money to get the coupon. Companies that offer coupons might actually collect some amount of money “in advance” from their prospective customers as a result of the fee paid by the user on the micro-transaction coupon system. Users get more value from having a micro-transaction account by being able to access valuable online coupons.

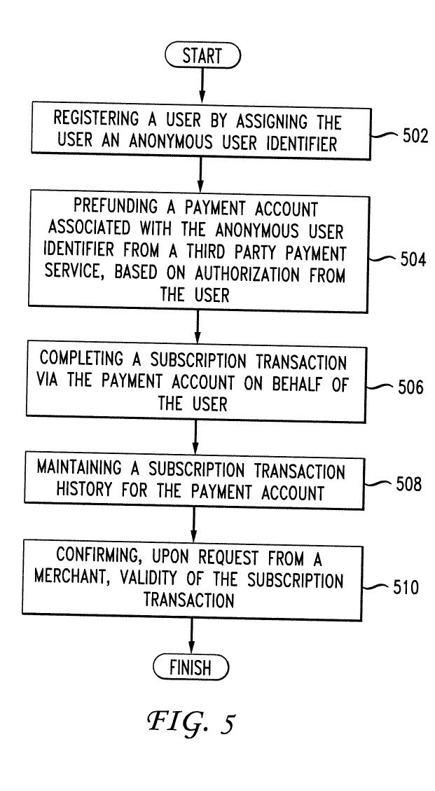

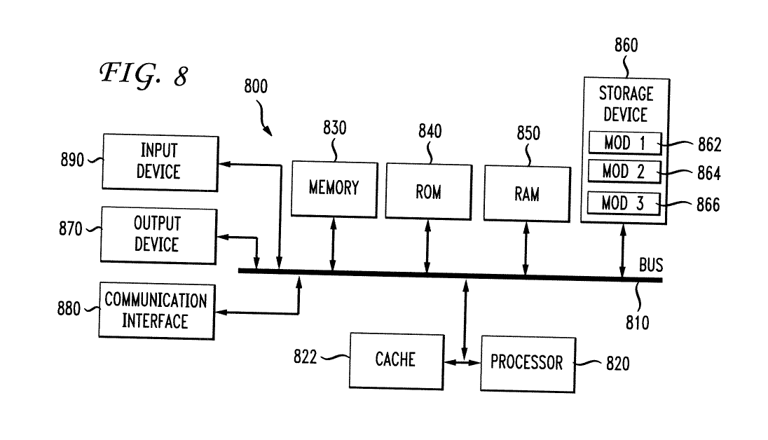

Having disclosed some basic system components and concepts, the disclosure now turns to the exemplary method embodiments shown in FIG. 5-7. For the sake of clarity, these methods are described in terms of an exemplary system 800 as shown in FIG. 8 configured to practice the method. The steps outlined herein are exemplary and can be implemented in any combination or appropriate order thereof, including combinations that exclude, add, or modify certain steps.

FIG. 5 illustrates a first example method embodiment for subscription purchases. The system can register a user by assigning the user an anonymous user identifier (502), and prefund a payment account associated with the anonymous user identifier from a third party payment service, based on authorization from the user (504). The system can complete a subscription transaction via the payment account on behalf of the user (506) as a micro-transaction. The subscription transaction can be associated with a piece of digital content, such a book, image, document, video, font, web page, and so forth. Alternatively, the subscription transaction can be associated with a computer-provided or computer-verified service. In one case, the subscription transaction provides the user access to the piece of digital content for at least one of a maximum number of accesses or for a subscription duration. The system can authorize the user upon receiving a subscription request from the user via a subscription button, by prompting the user to log in and, after the user has provided approved credentials, completing the subscription transaction.

The system can maintain a subscription transaction history for the payment account (508). The system can confirm, upon request from a merchant, validity of the subscription transaction based on the transaction history (510). The system can confirm the validity of the subscription while withholding from the merchant any identifying information about the user. The system can also, as set forth above, provide a user management portal for presenting the subscription transaction history and other account information to the user, and allowing the user to modify, export, view, search, and otherwise manage account information and transaction history data.

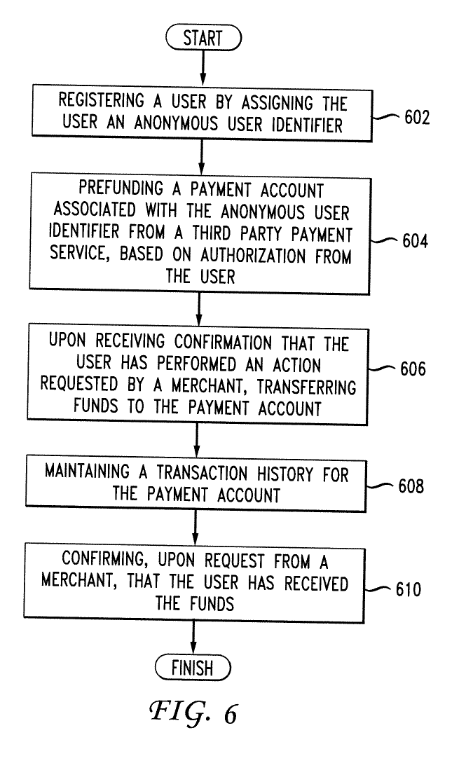

FIG. 6 illustrates a second example method embodiment for collecting rewards or gifts. In this embodiment, the system can register a user by assigning the user an anonymous user identifier (602). The system can prefund a payment account associated with the anonymous user identifier from a third party payment service, based on authorization from the user (604).

Upon receiving confirmation that the user has performed an action requested by a merchant, such as viewing an advertisement, the system can transfer funds to the payment account (606). The advertisement can be presented on a website, within an app or program, within a portal for viewing the transaction history for the payment account, and so forth. In one embodiment, the advertisement is presented via a publicly accessible device, such as a kiosk, a display on public transportation, or a display at a gas pump. The advertisements can be presented in virtually any location, as long as the micro-transaction system can identify the user, while keeping the user's identity anonymous to the merchant and/or advertiser. The system can maintain a transaction history for the payment account (608), and can confirm, upon request from a merchant, that the user has received the funds (610).

The system can further provide anonymous information about the user to the merchant, and select the advertisement based on specifications provided by the merchant. The amount of the funds provided in exchange for the advertisement can be determined based on a merchant-provided value for the advertisement and a desirability factor of the user for that particular advertisement. For example, presenting a make-up commercial to a young woman in her 20 s may be worth more than showing the same make-up commercial to a 4 year old male child. The system can maintain an action or viewing history for the user, and provide at least part of the action history to the merchant. The system can retrieve a maximum per-user and per-action limit established by the merchant, and verify that the user has not exceeded the per-user and per-action limit prior to transferring the funds to the payment account. In this way, a user is prevented from watching the same advertisement more than a maximum number of times intended by the merchant, simply to obtain the rewards.

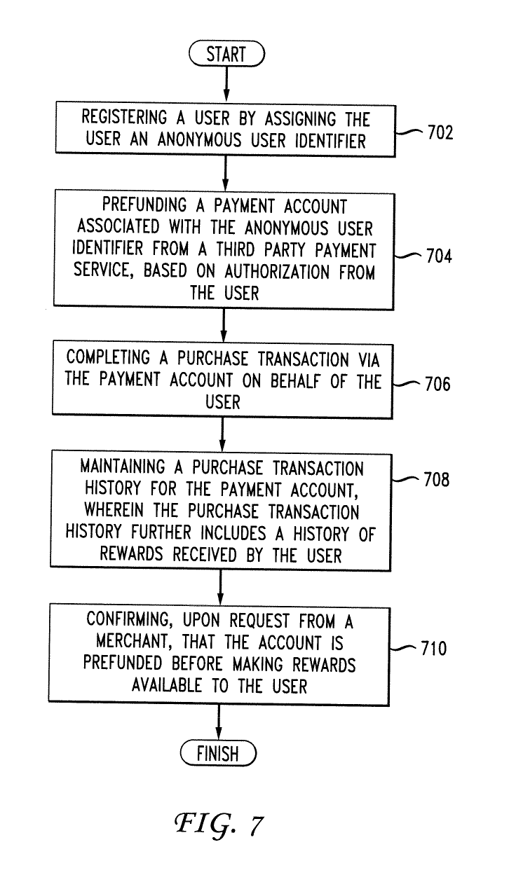

FIG. 7 illustrates a third example method embodiment incorporating purchases and rewards. The example micro-transaction system can register a user by assigning the user an anonymous user identifier (702), and prefund a payment account associated with the anonymous user identifier from a third party payment service, based on authorization from the user (704). Then, the system can complete a purchase transaction via the payment account on behalf of the user (706). The system can maintain a purchase transaction history for the payment account, wherein the purchase transaction history further includes a history of rewards received by the user (708), and confirm, upon request from a merchant, that the account is prefunded before making rewards available to the user (710).

Various embodiments of the disclosure are described in detail herein. While specific implementations are described, it should be understood that this is done for illustration purposes only. Other components and configurations may be used without parting from the spirit and scope of the disclosure. A brief description of a basic general purpose system or computing device in FIG. 8 which can be employed to practice the concepts, methods, and techniques disclosed is illustrated.

An exemplary system and/or computing device 800 includes a processing unit (CPU or processor) 820 and a system bus 810 that couples various system components including the system memory 830 such as read only memory (ROM) 840 and random access memory (RAM) 850 to the processor 820. The system 800 can include a cache of high speed memory connected directly with, in close proximity to, or integrated as part of the processor 820. The system 800 copies data from the memory 830 and/or the storage device 860 to the cache for quick access by the processor 820. In this way, the cache provides a performance boost that avoids processor 820 delays while waiting for data. These and other modules can control or be configured to control the processor 820 to perform various actions. Other system memory 830 may be available for use as well. The memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any general purpose processor and a hardware module or software module, such as module 8 862, module 2 864, and module 3 866 stored in storage device 860, configured to control the processor 820 as well as a special-purpose processor where software instructions are incorporated into the processor. The processor 820 may be a self-contained computing system, containing multiple cores or processors, a bus, memory controller, cache, etc. A multi-core processor may be symmetric or asymmetric.

The system bus 810 may be any of several types of bus structures including a memory bus or memory controller, a peripheral bus, and a local bus using any of a variety of bus architectures. A basic input/output (BIOS) stored in ROM 840 or the like, may provide the basic routine that helps to transfer information between elements within the computing device 800, such as during start-up. The computing device 800 further includes storage devices 860 such as a hard disk drive, a magnetic disk drive, an optical disk drive, tape drive or the like. The storage device 860 can include software modules 862, 864, 866 for controlling the processor 820. The system 800 can include other hardware or software modules. The storage device 860 is connected to the system bus 810 by a drive interface. The drives and the associated computer-readable storage media provide nonvolatile storage of computer-readable instructions, data structures, program modules and other data for the computing device 800. In one aspect, a hardware module that performs a particular function includes the software component stored in a tangible computer-readable storage medium in connection with the necessary hardware components, such as the processor 820, bus 810, display 870, and so forth, to carry out a particular function. In another aspect, the system can use a processor and computer-readable storage medium to store instructions which, when executed by the processor, cause the processor to perform a method or other specific actions. The basic components and appropriate variations can be modified depending on the type of device, such as whether the device 800 is a small, handheld computing device, a desktop computer, or a computer server.

Although the exemplary embodiment(s) described herein employs the hard disk 860, other types of computer-readable media which can store data that are accessible by a computer, such as magnetic cassettes, flash memory cards, digital versatile disks, cartridges, random access memories (RAMs) 850, read only memory (ROM) 840, a cable or wireless signal containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 800, an input device 890 represents any number of input mechanisms, such as a microphone for speech, a touch-sensitive screen for gesture or graphical input, keyboard, mouse, motion input, speech and so forth. An output device 870 can also be one or more of a number of output mechanisms known to those of skill in the art. In some instances, multimodal systems enable a user to provide multiple types of input to communicate with the computing device 800. The communications interface 880 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 820. The functions these blocks represent may be provided through the use of either shared or dedicated hardware, including, but not limited to, hardware capable of executing software and hardware, such as a processor 820, that is purpose-built to operate as an equivalent to software executing on a general purpose processor. For example the functions of one or more processors presented in FIG. 8 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 840 for storing software performing the operations described below, and random access memory (RAM) 850 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 800 shown in FIG. 8 can practice all or part of the recited methods, can be a part of the recited systems, and/or can operate according to instructions in the recited tangible computer-readable storage media. Such logical operations can be implemented as modules configured to control the processor 820 to perform particular functions according to the programming of the module. For example, FIG. 8 illustrates three modules Mod1 862, Mod2 864 and Mod3 866 which are modules configured to control the processor 820. These modules may be stored on the storage device 860 and loaded into RAM 850 or memory 830 at runtime or may be stored in other computer-readable memory locations.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

We claim:

1. A method comprising:
registering, via a processor, a user by assigning the user an anonymous user identifier;
prefunding a payment account associated with the anonymous user identifier from a third party payment service, based on authorization from the user;
completing a transaction via the payment account on behalf of the user;
maintaining a transaction history for the payment account; and
confirming, upon request from a merchant, validity of the transaction based on the transaction history.

2. The method of claim 1, wherein the transaction comprises at least one of a subscription transaction associated with a piece of digital content, a download of digital content, or a donation.

3. The method of claim 2, wherein the subscription transaction provides the user access to the piece of digital content for at least one of a maximum number of accesses or for a subscription duration.

4. The method of claim 1, further comprising:
receiving a transaction request from the user via a transaction button;
prompting the user to log in; and
upon receiving approved login credentials from the user, completing the transaction.

5. The method of claim 1, wherein confirming the validity of the transaction comprises withholding from the merchant identifying information about the user.

6. The method of claim 1, further comprising:
providing a user management portal for presenting the transaction history to the user.

7. The method of claim 1, wherein the transaction is a micro-transaction.

8. A system comprising:
a processor; and
a computer-readable storage medium storing instructions which, when executed by the processor, cause the processor to perform a method comprising:
registering a user by assigning the user an anonymous user identifier;
prefunding a payment account associated with the anonymous user identifier from a third party payment service, based on authorization from the user;
upon receiving confirmation that the user has performed an action requested by a merchant, transferring funds to the payment account;
maintaining a transaction history for the payment account; and
confirming, upon request from a merchant, that the user has received the funds.

9. The system of claim 8, wherein the action requested by the merchant comprises viewing an advertisement.

10. The system of claim 8, wherein the advertisement is presented within a portal for viewing the transaction history for the payment account.

11. The system of claim 9, the computer-readable storage medium further stores instructions which result in the method further comprising:
providing anonymous information about the user to the merchant; and
selecting the advertisement based on specifications provided by the merchant or an advertiser.

12. The system of claim 9, wherein the funds are determined based on a merchant-provided value for the advertisement.

13. The system of claim 8, the computer-readable storage medium further stores instructions which result in the method further comprising:
maintaining an action history for the user; and
providing at least part of the action history to the merchant.

14. The system of claim 8, the computer-readable storage medium further stores instructions which result in the method further comprising:
retrieving a maximum per-user and per-action limit established by the merchant; and
verifying that the user has not exceeded the per-user and per-action limit prior to transferring the funds to the payment account.

15. A computer-readable storage device storing instructions which, when executed by a computing device, cause the computing device to perfoun a method comprising:
registering a user by assigning the user an anonymous user identifier;
prefunding a payment account associated with the anonymous user identifier from a third party payment service, based on authorization from the user;
completing a purchase transaction via the payment account on behalf of the user;
maintaining a purchase transaction history for the payment account, wherein the purchase transaction history further includes a history of rewards received by the user; and
confirming, upon request from a merchant, that the payment account is prefunded before making awards available to the user.

16. The computer-readable storage device of claim 15, wherein the purchase transaction is a purchase of a subscription, a donation or a download of digital content.

17. The computer-readable storage device of claim 16, wherein the purchase of the subscription provides the user access to a piece of digital content for at least one of a maximum number of accesses or for a subscription duration.

18. The computer-readable storage device of claim 15, wherein the purchase transaction is a purchase of a coupon.

19. The computer-readable storage device of claim 18, storing additional instructions which result in the method further comprising:
tracking user purchases of coupons; and
reporting user purchases of coupons to a set of merchants offering coupons for purchase.

20. The computer-readable storage device of claim 15, wherein the purchase transaction is a micro-transaction.
